(19) United States
(12) Patent Application Publication
(10) Pub. No.: US 2026/0050483 A1
(43) Pub. Date: Feb. 19, 2026

(54) PERFORMANCE MONITORING USING OBSERVABILITY DATA

(71) Applicant: INTERNATIONAL BUSINESS MACHINES CORPORATION, ARMONK, NY (US)

(72) Inventors: Rajesh Kumar Jeyapaul, Bangalore (IN); Bikram Debnath, Bangalore (IN); Chinmay Dayanand Samant, Colvale (IN); Shibu N, Trivandrum (IN); Joice Joy, Kottayam (IN)

(21) Appl. No.: 18/807,863

(22) Filed: Aug. 16, 2024

(51) Int. Cl. G06F 9/50

(52) U.S. Cl. CPC G06F 9/5038

(57) ABSTRACT

A method and system for performance monitoring by generating a number of observability operations about one or more targets in a target system and converting the number of observability operations into a set of nodes, each node defining how and where an observability operation is performed to fetch corresponding observability data from the target system. The method and system include setting a priority for each node, the nodes being stored in a first or second heap to be retrievable based on the priority, and retrieving, the nodes for execution in a first mode of operation, or in a second mode of operation, based on observability data and instructions to conserve resource.

### BACKGROUND

### Technical Field

The present disclosure generally relates to monitoring application and infrastructure performance, and more particularly, to optimizing the retrieval of observability data by dynamically recalibrating the priority of observability operations to reduce impact on a target system and environment.

### Description of the Related Art

An application performance monitoring or management (APM) system is a tool that an enterprise may use to assess the states of applications, hosts or other targets operating in a data center, such as availability, load, latency, and other performance metrics.

A goal of APM may be to ensure that targets run smoothly, meet performance standards, and deliver a high-quality user experience and the goal may be achieved by monitoring end-user experience, observing how the components of target interact during execution, and aggregates data on application performance.

### BRIEF SUMMARY

According to an embodiment of the present disclosure, a computer-implemented method includes generating a number of observability operations about one or more targets in a target system and converting the plurality of observability operations into a set of nodes, each node defining how and where an observability operation is performed to fetch corresponding observability data from the target system. The method further includes setting a priority for each node of the set of nodes. The nodes are stored in a first or second heap of a heap store to be subsequently retrievable based on the priority. The retrieving includes retrieving in a first mode of operation, a node from the first heap of the heap store and performing the observability operation of the retrieved node on the target system. The retrieving can also be performed in a second mode of operation responsive to receiving instructions to conserve resource, to retrieve another node from the second heap of the heap store and perform the observability operation of the retrieved another node on the target system.

In one embodiment, the manner of operating the first heap and second heaps are switchable. The first heap is operated in the first mode of operation to store nodes that include observability operations ready to be executed on the target system and the second heap is operated to store recalibrated nodes. Upon the switch to the second mode of operation, the second heap is operated to store nodes that include observability operations ready to be executed on the target system and the first heap is operated to store recalibrated nodes.

According to an embodiment of the present disclosure, a computing device has a processor and a memory, in communication with the processor, with one or more computer program instructions stored on the memory. The computer program instructions, when executed by the processor, cause the computing device to perform operations including generating a plurality of observability operations about one or more targets in a target system, and converting the plurality of observability operations into a set of nodes. Each node defines how and where an observability operation is performed to fetch corresponding observability data from the target system. A priority is set for each node of the set of nodes, each node being stored in a first or second heap of a heap store to be retrievable based on the priority. In a first mode of operation, a node from the first heap of the heap store is retrieved and the observability operation of the retrieved node is performed on the target system. In a second mode of operation, responsive to receiving a resource conservation start instruction, another node from the second heap of the heap store is retrieved and the observability operation of the retrieved another node is performed on the target system.

According to an embodiment of the present disclosure, a computer program product, includes one or more computer-readable storage devices and program instructions stored on the at least one of the one or more computer-readable storage devices. The program instructions are executable by a processor to generate a plurality of observability operations about one or more targets in a target system, convert the plurality of observability operations into a set of nodes, each node defining how and where an observability operation is performed to fetch corresponding observability data from the target system. The program instructions further configure the processor to set a priority for each node of the set of nodes, each node being stored in a first or second heap of a heap store to be retrievable based on the priority. The program instructions further configure the processor to, a first mode of operation, retrieve a node from the first heap of the heap store and perform the observability operation of the retrieved node on the target system. The program instructions further configure the processor to, in a second mode of operation, responsive to receiving a resource conservation start instruction, retrieve another node from the second heap of the heap store and perform the observability operation of the retrieved another node on the target system.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a computing environment in accordance with an illustrative embodiment.

FIG. 3 depicts a system for performance monitoring in accordance with an illustrative embodiment.

FIG. 4 depicts a user configuration in accordance with an illustrative embodiment.

FIG. 5 depicts a table showing nodes in accordance with an illustrative embodiment.

FIG. 6 depicts a table showing recalibrated nodes in accordance with an illustrative embodiment.

FIG. 7 depicts a heap creator creating a first heap and a second heap in accordance with an illustrative embodiment.

FIG. 8 depicts a routine for performance monitoring in accordance with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

It is recognized that monitoring application and infrastructure behavior may include gathering the performance metrics of targets such as applications, hosts, virtual machines, database servers, and Kubernetes clusters at frequent intervals. However, when a target is under maximum utilization, any extra activity to collect observability metrics may cause significant impact on the target. For example, rampant data collection by an observability system, may cause significant impact on the target. Further, increase in a number of users may increase transactions which also increases data collection.

The illustrative embodiments provide an efficient and sustainable technique to collect the observability metrics without significant impact on the target system and environment. The illustrative embodiments provide a monitoring system configured to collect possible metrics through various operations, such as though Structured Query Language (SQL) Queries, Application Programming Interface (API) Endpoints, Shell commands, etc., to probe the underlying target.

The illustrative embodiments disclose a computer-implemented method that includes generating a plurality of observability operations about one or more targets in a target system, converting the plurality of observability operations into a set of nodes, each node defining how and where an observability operation is performed to fetch corresponding observability data from the target system as defined in a user configuration, setting a priority for each node of the set of nodes, and storing the nodes in a first or second heap of a heap store to be retrievable based on the priority. Subsequently, in a first mode of operation, a node from the first heap of the heap store is retrieved and the observability operation of the retrieved node is performed on the target system. Further, responsive to receiving an instruction to conserve computational resource, in a second mode of operation, another node from the second heap of the heap store, which is configured to recalibrate node priorities, is retrieved. The observability operation of the retrieved another node is then performed on the target system. The modes of operation are selectively switched in a temporal fashion to conserve computational resources of the target or target system 306.

In one embodiment, certain operations are described as occurring at a certain component or location. Such locality of operations is not intended to be limiting. Any operation described herein as occurring at or performed by a particular component, can be implemented in such a manner that one component-specific function causes an operation to occur, or be performed, at another component, e.g., at a local or remote engine, respectively. In one embodiment, the method described herein, is implemented to execute on a particularly configured computing device or data processing system and provides substantial advancement of the functionality of that computing device or data processing system. Embodiments thus have the capacity to improve the technical field of performance monitoring using observability data. For example, as opposed to using a filter or setting a priority to a selected entity for sustainable data collection, the illustrative embodiments can utilize collective decision making to manage thousands of entities with a careful observation and methodology, wherein the performance impact of an observability backend engine is optimized through automatically and dynamically changing queries and priority indices computed using volume of data retrieved, latency or other performance metrics to execute the observation data collection.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

The illustrative embodiments are described with respect to certain types of machines. The illustrative embodiments are also described with respect to other scenes, subjects, measurements, devices, data processing systems, environments, components, and applications, by way of example only. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

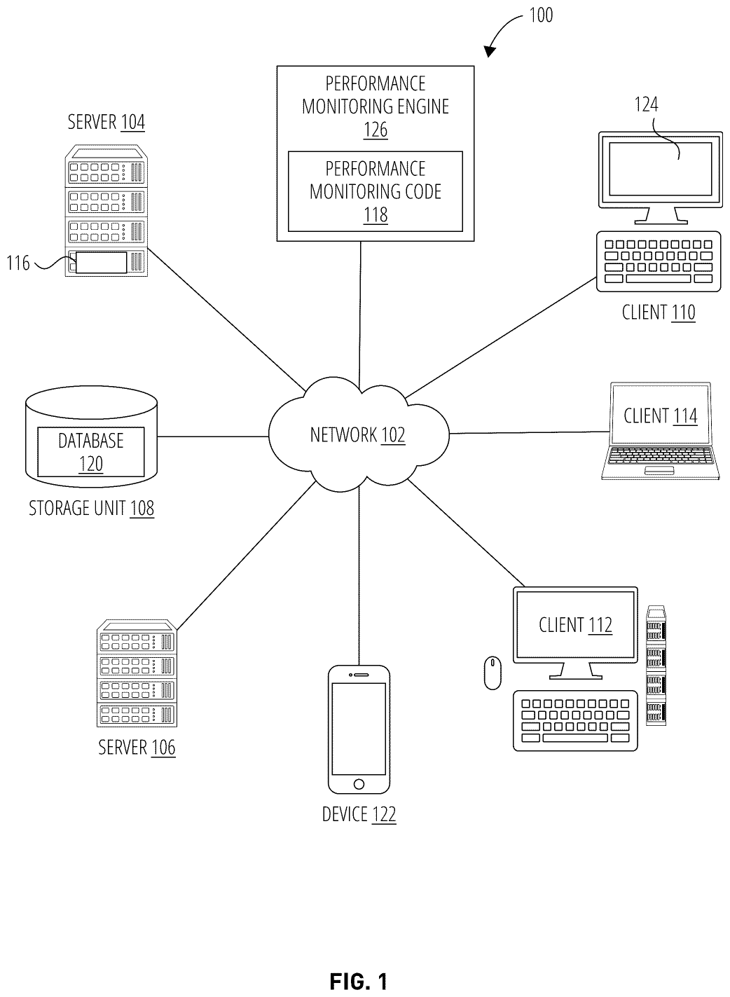

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), performance monitoring engine 126, server 104, server 106, and device 122, may include data and may have software applications or software tools executing thereon.

Only as an example, and without implying any limitation to such architecture, FIG. 1 depicts certain components that are usable in an example implementation of an embodiment. Data processing systems (performance monitoring engine 126, server 104, server 106, client 110, client 112, client 114, and device 122) also represent examples in a cluster, partitions, and other configurations suitable for implementing an embodiment.

Server 104, server 106, storage unit 108, client 110, client 112, client 114, device 122, performance monitoring engine 126 may couple to network 102 using wired connections, wireless communication protocols, or other suitable data connectivity. Client 110, client 112 and client 114 may be, for example, personal computers or network computers. Any of the clients may include a client application 124.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Performance monitoring engine 126 may also be a part of or separate from server 104 or server 106. Server application 116, and/or performance monitoring engine 126 may include performance monitoring code 118 configured for performance monitoring using observability data.

Device 122 is an example of a device described herein. For example, device 122 can take the form of a smartphone, a tablet computer, a laptop computer, client 110 in a stationary or a portable form, or any other suitable device. Database 120 of storage unit 108 may store one or more information for operations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as performance monitoring code 118. In addition to the performance monitoring code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and the performance monitoring code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

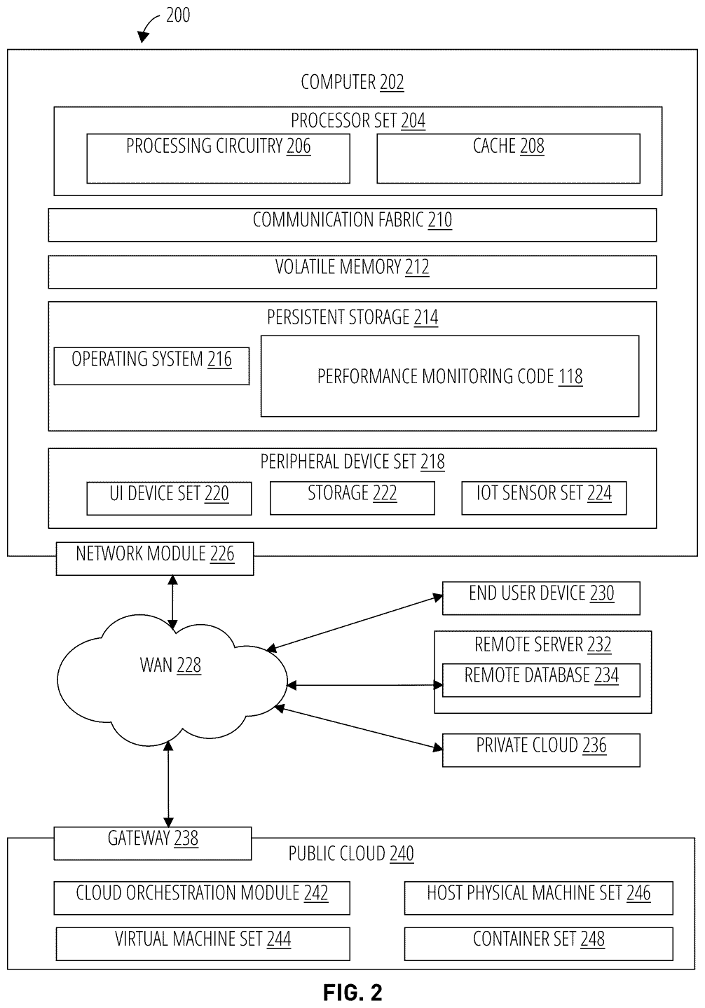

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in the performance monitoring code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in the performance monitoring code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

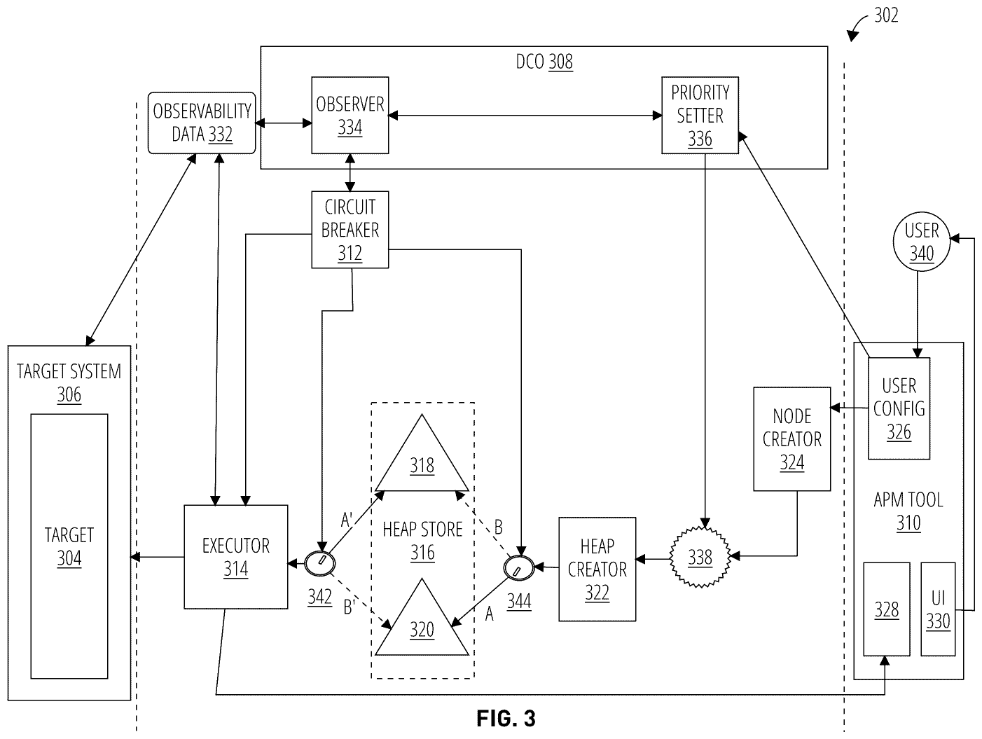

Reference is now made to FIG. 3 which illustrates an architecture of a performance monitoring system 302 in accordance with one or more embodiments. The performance monitoring system 302 may employ the performance monitoring engine 126 for performing all or a subset of the functions discussed herein. The performance monitoring engine 126 may be operated based on performance monitoring code 118 to collect the observability data without significant impact on a target system and environment.

The performance monitoring system 302 comprises an application performance monitoring tool 310 used by a user 340 to monitor the performance of targets 304, such as applications, hosts, virtual machines, database servers, and Kubernetes clusters. The user 340 may initially provide a user configuration 326 that provides target preferences and configurations meant to aid in connecting to the executor 314 or the target 304 to receive observability data 332 which is used by the data collection optimizer 308 as well as the backend 328 of the application performance monitoring tool 310. The observability data 332 may comprise utilization or performance metrics of the target 304 such as a volume of data fetched and used by the user, load, latency, CPU utilization percentages, how other targets 304 behave on the target system 306, and other performance metrics or the targets 304. The user configuration 326 may be optional, and in some cases, is used for an initial setup by the node creator 324.

The node creator 324 generates a plurality of observability operations about one or more targets in a target system. The observability operations can include, for example, a list of SQL Queries, API Endpoints, Shell commands, or other operations that can be executed by the executor 314 to obtain observability data 332. The node creator 324 further converts the observability operations into a set of nodes 338, each node defining how and where an observability operation is performed to fetch corresponding observability data 332 from the target 304 or target system 306.

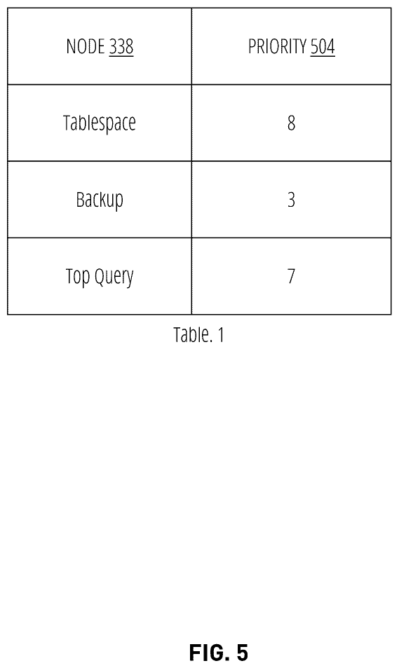

A node 338 corresponds to a data collection task and may further comprise a priority 504 (see FIG. 5) that provides information about an importance of the data collection task. For example, one node may be related to collecting information about CPU utilization. The node may thus include, for example, an SQL query or other metadata information that may be executed to get the data from the target 304. The priority 504 can be another attribute of the node 338.

In some embodiments, the, nodes 338 (including the priorities and information about the observability operations), may be initially generated using the user configuration 326 and then dynamically updated as described herein. As illustrated in FIG. 3, the priority setter 336 may dynamically provide the nodes 338 with priorities 504.

The heap creator 322 is configured to create in heap store 316 including at least a first heap 318 and a second heap 320 for storing the nodes 338. More specifically, the heaps may be data structures which store the nodes 338 in a sorted format. In an example, the heaps are max heaps, which are generated as binary trees in which a value of a vertex/node of a binary tree is greater than or equal to each of the values of children of the vertex. The priorities 504 of the nodes 338 may be used for the order of sorting/storage, such that nodes 338 with higher priorities or more relevant nodes are retrieved first, before nodes with lower priorities 504 are retrieved. For example, nodes 338 with comparatively higher priorities are stored in the heap store to be retrievable before the nodes with comparatively lower priorities. The priorities can be dynamically generated by the priority setter 336 of the data collection optimizer 308 and can be initially influenced by the user configuration 326.

In one embodiment, the nodes 338 from the node creator 324 are initially created based on the user configuration 326 and stored in the first heap 318 for retrieval by the executor 314, before any recalibration of the priorities of the nodes is performed with the priority setter 336. Upon recalibration, the recalibrated nodes with altered priorities may be stored in the second heap 320.

The heaps can be operated in an alternating fashion to facilitate sustainable collection of observability data 332. More specifically, the heaps may be operated differently in a first or second mode of operation. In the first mode of operation, the first heap 318 is operated to store nodes 338 comprising observability operations to be executed on the target system 306 (see B) and the second heap 320 is operated to store recalibrated nodes (see A). The executor 314 retrieves the nodes 338 of the first heap 318 according to their priorities for execution in the first mode of operation (see A′). In the second mode of operation, the second heap 320 which was previously used to store recalibrated nodes is now used by the executor 314 for node retrieval for performing observability operations (see B′). More specifically, in the second mode of operation, the second heap 320 is operated to store nodes 338 that are to be executed on the target system 306 (see A) and the first heap 318 is operated to store recalibrated nodes (see B).

The switching between the first mode of operation and the second mode of operation can be performed by the observer 334, which uses the circuit breaker 312 to operate flip flops or switches (342, 344) based on target or system utilization metrics obtained from the observability data 332. For example, the second mode of operation is performed upon receiving a resource conservation start instruction from the data collection optimizer 308. More specifically, at any given point in time, the executor 314 is connected to one of the two heaps of the heap store 316 to perform an observability operation, while the heap is used for recalibration of the dynamic priorities 504. Responsive to the data collection optimizer 308 computing a heavy resource utilization for observability operation of the executor 314, the data collection optimizer 308 may trigger a regeneration sequence as part of the functions of the priority setter 336 wherein the priorities of the nodes 338 are updated. In general, the priorities of the nodes 338 may be updated at any point in time such as in response to any new observability operation being executed or at predetermined intervals.

When the data collection optimizer 308 discovers, through the observability data 332, that a resource utilization criterion has failed, the data collection optimizer 308 can generate a resource conservation start instruction to activate the second mode of operation and conserve computing resources. Accordingly, the data collection optimizer 308 operates the circuit breaker 312 to terminate the execution of the current heap and operates the flip flops or switches (342, 344) to switch the connection of the executor 314 from the current heap to the other heap, which has recalibrated priories that were generated over the time by the data collection optimizer 308 to identify a best new course of action, in a resource conservation scenario. Thus, the new order of execution may provide a best candidate for more efficient and sustainable execution of observability operations. For example, the priorities of observability operations that consume more CPU may be reduced. The switching ensures that the targets 304 running on the target system 306 are not affected due to overwhelming computing resource demands of the observability operations without compromising the mission critical observability data 332. Accordingly, the switching can improve the efficiency and sustainability of the performance monitoring system 302.

When the data collection optimizer 308 discovers through the observability data 332 that the resource utilization criteria has passed (for example, the resource utilization is below a threshold percentage), a resource conservation end instruction may be generated by the performance monitoring system 302, and the modes of operation may be switched from the second mode of operation (current mode) back to the first mode of operation (previous mode). Thus, the modes may be selectively switched based on the observability data 332.

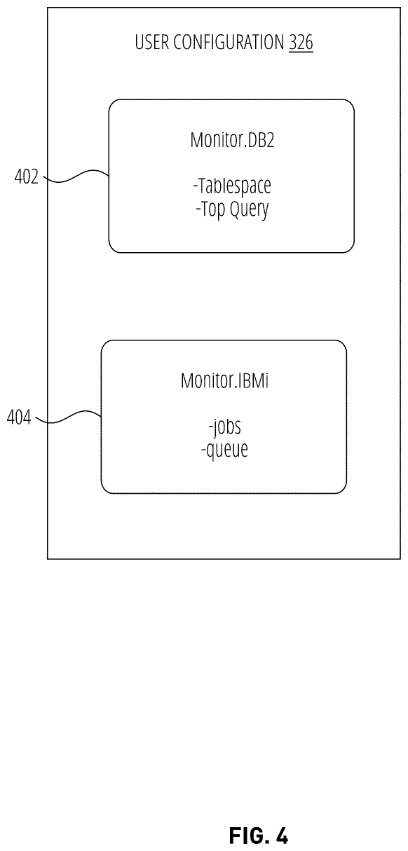

FIG. 4 illustrates and example user configuration 326 comprising a first configuration 402 and a second configuration 404. The configurations show the example systems and applications for which observability operations may be performed on by the executor 314.

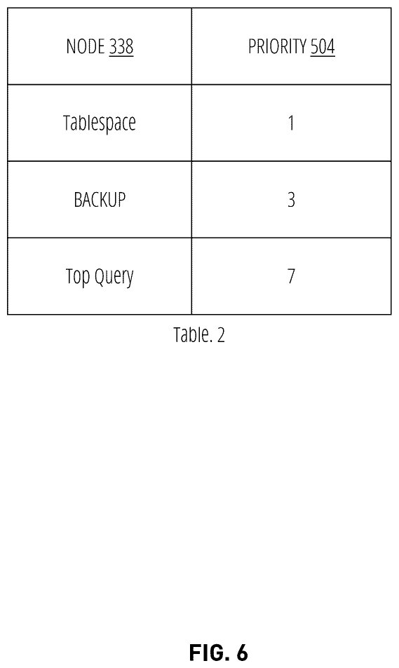

FIG. 5 illustrates a table showing example nodes 338 and priorities 504. As depicted in FIG. 5, the node “Tablespace” may have a priority of 8. The node “Backup” has a priority of 3 and the node “Top Query” has a priority of 7. Responsive to obtaining observability data 332 during an observability operation corresponding to “Tablespace”, the data collection optimizer 308 reduces, as shown in FIG. 6 (Table. 2), the priority of “Tablespace” to 1. This may be because, for example, an application becomes more computing resource intensive as many users start using the application, and thus, increasing the generation or probability of generation of more table space. The increase can impact the data collection specific to “Tablespace” node. Thus, the priority of the “Tablespace” node is reduced by the priority setter 336 of the data collection optimizer 308.

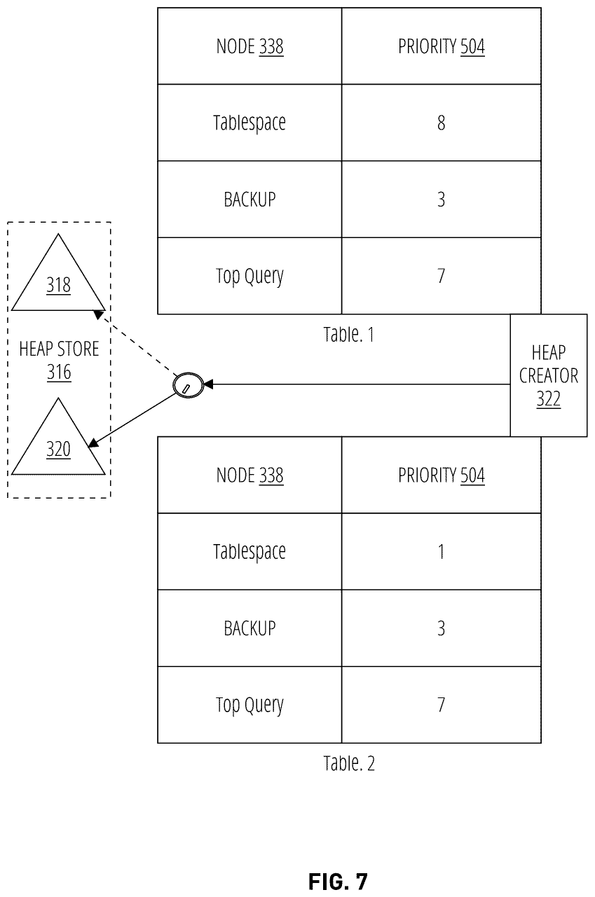

Turning to FIG. 7, the figure illustrates a mode of operation wherein the reduced priority node details of Table. 2 are generated with the second heap 320. The original priority node details of Table. 1 are stored in the first heap 318 and may be used by the executor 314 for observability operations until a switch in the mode of operations is triggered.

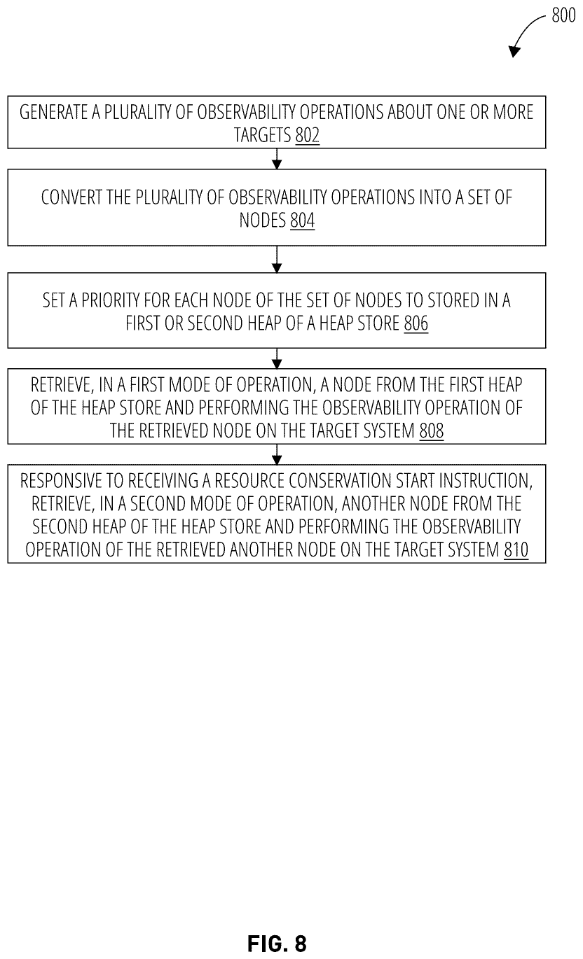

FIG. 8 illustrates a routine 800 for automatic recovery of virtual machines in accordance with an illustrative embodiment. The routine 800 may be performed with the performance monitoring engine 126.

In block 802, the performance monitoring engine 126 generates a plurality of observability operations about one or more targets in a target system.

In block 804, the performance monitoring engine 126 converts the plurality of observability operations into a set of nodes 338. Each node of the set of nodes dictates how and where an observability operation is performed to fetch corresponding observability data from the target system. In some cases, the nodes 338 are objects that store data.

In block 806, the performance monitoring engine 126 sets a priority 504 for each node of the set of nodes. The nodes 338 are stored in a first heap 318 or second heap 320 of a heap store to be retrievable based on the priority 504.

In block 808, the performance monitoring engine 126 retrieves, in a first mode of operation, a node 338 from the first heap 318 of the heap store 316 and performs the observability operation of the retrieved node on the target system 306. In the first mode of operation, the performance monitoring engine 126 further recalibrates the priority 504 for one or more node 338 of the set of nodes to generate recalibrated one or more nodes and storing the recalibrated one or more nodes in the second heap 320. In an embodiment, recalibrating includes reducing the priority of the nodes that cause more impact to the target 304 or target system 306. The first mode of operation may correspond to a mode in which a resource utilization of the target system meets a resource utilization criterion, which may be predetermined.

In block 810, the performance monitoring engine 126 retrieves in a second mode of operation, responsive to receiving a resource conservation start instruction, another node from the second heap 320 of the heap store 316 and performs the observability operation of the retrieved another node on the target system. In the second mode of operation, the performance monitoring engine 126 further recalibrates one or more nodes of the set of nodes to generate recalibrated nodes and stores the recalibrated nodes in the first heap 318. Thus, operations of the first and second heaps are switched in the second mode of operation. The second mode of operation corresponds to a mode in which a resource utilization of the target system fails to meet a resource utilization criterion.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for performance monitoring, comprising:
generating a plurality of observability operations about one or more targets in a target system;
converting the plurality of observability operations into a set of nodes, wherein respective nodes of the set of nodes define how and where a respective observability operation is performed to fetch corresponding observability data from the target system;
setting a priority for the set of nodes, at least one node of the set of nodes being stored in a first heap or a second heap of a heap store, the set of nodes being retrievable from the heap store based on the priority;
retrieving, in a first mode of operation, a node from the first heap of the heap store and performing the respective observability operation of the retrieved node on the target system; and
responsive to receiving a resource conservation start instruction, retrieving, in a second mode of operation, another node from the second heap of the heap store and performing the respective observability operation of the retrieved another node on the target system.

2. The computer-implemented method of claim 1, further comprising recalibrating, in the first mode of operation, the priority for one or more nodes of the set of nodes to generate the recalibrated one or more nodes and storing the recalibrated one or more nodes in the second heap.

3. The computer-implemented method of claim 2, wherein the first mode of operation corresponds to a mode in which a resource utilization of the target system meets a resource utilization criterion.

4. The computer-implemented method of claim 1, further comprising recalibrating, in the second mode of operation, the priority for one or more nodes of the set of nodes to generate the recalibrated one or more nodes and storing the recalibrated one or more nodes in the first heap.

5. The computer-implemented method of claim 4, wherein the second mode of operation corresponds to another mode in which a resource utilization of the target system fails to meet a resource utilization criterion.

6. The computer-implemented method of claim 5, further comprising receiving a resource conservation end instruction and switching from the second mode of operation back to the first mode of operation.

7. The computer-implemented method of claim 1, wherein the first and second heaps are max heaps which are generated as binary trees in which a value of a vertex of a binary tree is greater than or equal to each of the values of children of the vertex.

8. The computer-implemented method of claim 1, further comprising setting the priority based on observability data received from an executor that performs the respective observability operation on the target system.

9. The computer-implemented method of claim 8, wherein the priority is further set based on a user configuration.

10. The computer-implemented method of claim 1, wherein:
in the first mode of operation, the first heap is operated to store nodes that include respective observability operations ready to be executed on the target system and the second heap is operated to store recalibrated nodes; and
in the second mode of operation, the second heap is operated to store nodes that include respective observability operations ready to be executed on the target system and the first heap is operated to store recalibrated nodes.

11. A computing device for performance monitoring comprising:
a processor; and
a memory, in communication with the processor, with one or more computer program instructions stored on the memory, the computer program instructions, when executed by the processor, cause the computing device to perform operations comprising:
generating a plurality of observability operations about one or more targets in a target system;
converting the plurality of observability operations into a set of nodes, wherein respective nodes of the set of nodes define how and where a respective observability operation is performed to fetch corresponding observability data from the target system;
setting a priority for the set of nodes, at least one node of the set of nodes being stored in a first heap or a second heap of a heap store, the set of nodes being retrievable from the heap store based on the priority;
retrieving, in a first mode of operation, a node from the first heap of the heap store and performing the respective observability operation of the retrieved node on the target system; and
responsive to receiving a resource conservation start instruction, retrieving, in a second mode of operation, another node from the second heap of the heap store and performing the respective observability operation of the retrieved another node on the target system.

12. The computing device of claim 11, wherein the execution of the program instructions by the processor further configures the computing device to perform operations comprising:
recalibrating, in the first mode of operation, the priority for one or more nodes of the set of nodes, to generate the recalibrated one or more nodes; and
storing, in the first mode of operation, the recalibrated one or more nodes in the second heap.

13. The computing device of claim 12, wherein the first mode of operation corresponds to a mode in which a resource utilization of the target system meets a resource utilization criterion.

14. The computing device of claim 11, wherein the execution of the program instructions by the processor further configures the computing device to perform operations comprising recalibrating, in the second mode of operation, the priority for one or more nodes of the set of nodes to generate the recalibrated one or more nodes and storing the recalibrated one or more nodes in the first heap.

15. The computing device of claim 14, wherein the second mode of operation corresponds to another mode in which a resource utilization of the target system fails to meet a resource utilization criterion.

16. The computing device of claim 11, wherein the execution of the program instructions by the processor further configures the computing device to perform operations comprising receiving a resource conservation end instruction and switching from the second mode of operation back to the first mode of operation.

17. The computing device of claim 11, wherein the first and second heaps are max heaps which are generated as binary trees in which a value of a vertex of a binary tree is greater than or equal to each of the values of children of the vertex.

18. A computer program product for performance monitoring, the computer program product comprising:
one or more computer-readable storage devices and program instructions stored on the at least one of the one or more computer-readable storage devices, wherein an execution of the program instructions causes a computing device to carry out a method comprising:
generating a plurality of observability operations about one or more targets in a target system;
converting the plurality of observability operations into a set of nodes, wherein respective nodes of the set of nodes define how and where a respective observability operation is performed to fetch corresponding observability data from the target system;
setting a priority for the set of nodes, at least one node of the set of nodes being stored in a first heap or a second heap of a heap store, the set of nodes being retrievable from the heap store based on the priority;
retrieving, in a first mode of operation, a node from the first heap of the heap store and performing the respective observability operation of the retrieved node on the target system; and
retrieving, in a second mode of operation, responsive to receiving a resource conservation start instruction, another node from the second heap of the heap store and performing the respective observability operation of the retrieved another node on the target system.

19. The computer program product of claim 18, the method further comprising:
recalibrating, in the first mode of operation, the priority for one or more nodes of the set of nodes to generate the recalibrated one or more nodes; and
storing, in the first mode of operation, the recalibrated one or more nodes in the second heap.

20. The computer program product of claim 18, the method further comprising recalibrating, in the second mode of operation, the priority for one or more nodes of the set of nodes to generate the recalibrated one or more nodes and storing the recalibrated one or more nodes in the first heap.
